(19) United States
(12) Patent Application Publication
(10) Pub. No.: US 2026/0010928 A1
(43) Pub. Date: Jan. 8, 2026

(54) INFORMATION PROCESSING DEVICE THAT EXTRACTS DATA FOR DIGITAL MARKETING IN MEDICAL FIELD

(71) Applicant: TCROSS Co., Ltd., Tokyo (JP)

(72) Inventors: Satoru Hashimoto, Tokyo (JP); Yoshihiro Motozawa, Tokyo (JP)

(73) Assignee: TCROSS Co., Ltd., Tokyo (JP)

(21) Appl. No.: 19/327,232

(22) Filed: Sep. 12, 2025

Related U.S. Application Data
(63) Continuation of application No. PCT/JP2024/009078, filed on Mar. 8, 2024.

(30) Foreign Application Priority Data
Mar. 13, 2023 (JP) 2023-038819

(51) Int. Cl. G06Q 30/0241

(52) U.S. Cl. CPC G06Q 30/0277

(57) ABSTRACT

An information processing device stores medical content information viewable or browsable on a Web site and tag information classifying the medical content information to be associated with each other; stores user behavior information that associates user identification information, the tag information corresponding to the medical content information viewed or browsed by a user, and a number of times of viewing or browsing per the tag information with one another; stores user attribute information that associates the user identification information and attribute information including viewing/browsing situation information of the medical content information viewed or browsed by the user with each other; normalizes the number of times of viewing or browsing per the tag information to represent a frequency of viewing or browsing by the user; and applies factor analysis processing to the user behavior information after the normalizing to calculate a predetermined number of common factors.

### CROSS-REFERENCE TO RELATED APPLICATIONS

This is the continuation application of PCT/JP/2024/009078, and the entire disclosure of Japanese Patent Application No. 2023-038819 filed on Mar. 13, 2023, including description, claims, drawings and abstract is incorporated herein by reference.

### BACKGROUND

### Technical Field

It relates to the technology of digital marketing in the medical field.

### Description of Related Art

In corporate operations, whether manufacturing or service, marketing is a very important activity in developing and maintaining their competitive advantage.

On the other hand, in recent years, advertisement and sales activities in companies are often performed by making full use of digital technologies such as Web, the Internet, and AI (Artificial Intelligence), and marketing activities of companies also tend to be developed based on digital technologies.

Under such a background, technical proposals related to marketing have been actively made in various industries. For example, Patent Document 1 proposes a technique of collecting various behavior examples of a user in a wide range and performing access analysis with high accuracy, and Patent Document 2 proposes an information processing device that performs display capable of suitably grasping an effect of learning.

In addition, Patent Document 3 proposes a technique for enhancing an advertisement effect and analysis accuracy in Web advertisement distribution according to characteristics of a user, and Patent Document 4 proposes an information distribution server capable of enhancing an advertisement effect by distribution information.

### PATENT LITERATURE

Patent Document 1: Japanese Unexamined Patent Application Publication No. 2022-009936
Patent Document 2: Japanese Unexamined Patent Application Publication No. 2021-056364
Patent Document 3: Japanese Patent No. 5878218
Patent Document 4: Japanese Unexamined Patent Application Publication No. 2010-178176

However, in the related art described above, characteristics of customers in the medical field are not taken into consideration and it is difficult to apply the related art to marketing in the medical field.

### SUMMARY

One or more embodiments of the present invention provide an information processing device that generates data for accurately finding features of a customer candidate in order to realize effective digital marketing in the medical field.

According to a first aspect of the present invention, an information processing device comprises:
a content information memory;
a user behavior information storage;
a user attribute information storage; and a central processing unit (CPU) that:
stores, in the content information memory, medical content information viewable or browsable on a Web site and tag information classifying the medical content information to be associated with each other,
stores, in the user behavior information storage, user behavior information that associates user identification information, the tag information corresponding to the medical content information viewed or browsed by a user identified by the user identification information, and a number of times of viewing or browsing per the tag information with one another,
stores, in the user attribute information storage, user attribute information that associates the user identification information and attribute information including viewing/browsing situation information of the medical content information viewed or browsed by the user with each other,
normalizes the number of times of viewing or browsing per the tag information to represent a frequency of viewing or browsing by the user;
applies factor analysis processing to the user behavior information after the normalizing to calculate a predetermined number of common factors;
calculates a factor score of the user behavior information after the normalizing based on the predetermined number of common factors per the user identification information, and detects one of the common factors having a highest score as a user characteristic of the user identified by the user identification information;
integrates the user attribute information and the user characteristic based on the user identification information, and generates user integrated information used for attribute analysis by multivariate analysis of an event of satisfying a predetermined viewing or browsing situation with respect to the medical content information viewed or browsed by the user;
with respect to the user integrated information, identifies, by multivariate analysis, an item of the attribute information including the viewing/browsing situation information of the medical content information viewed or browsed by the user, the item of the attribute information contributing to the event of satisfying the predetermined viewing or browsing situation suggesting that the user is deeply interested in the medical content information viewed or browsed by the user; and
based on the user integrated information, extracts the user identification information having a predetermined user characteristics and satisfying a condition of the item of the attribute information that has been identified.

According to a second aspect of the present invention, an information processing device comprises:
a content information memory;
a user behavior information storage;
a user attribute information storage;
a product selective use information memory;
a correspondence relation memory; and
a central processing unit (CPU) that:
stores, in the content information memory, medical content information viewable or browsable on a Web site and tag information classifying the medical content information to be associated with each other,
stores, in the user behavior information storage, user behavior information that associates user identification information, the tag information corresponding to the medical content information viewed or browsed by a user identified by the user identification information, and a number of times of viewing or browsing per the tag information with one another,
stores, in the user attribute information storage, user attribute information that associates the user identification information and a plurality of pieces of attribute information including viewing/browsing situation information of the medical content information viewed or browsed by the user with each other,
normalizes the number of times of viewing or browsing per the tag information to represent a frequency of viewing or browsing by the user,
applies factor analysis processing to the user behavior information after the normalizing to calculate a predetermined number of common factors,
calculates a factor score of the user behavior information after the normalizing based on the predetermined number of common factors per the user identification information, and detects one of the common factors having a highest score as a user characteristic of the user identified by the user identification information,
stores, in the product selective use information memory, product selective use information that associates the user identification information, a plurality of pieces of attribute information of the user identified by the user identification information, and selective use information for a plurality of selective use targets of a plurality of medical products having a same effect as an effect of a medical product used by the user identified by the user identification information,
stores, in the correspondence relation memory, a correspondence relation between the user characteristics, and the selective use targets and the pieces of attribute information, and
applies a multivariate analysis based on the product selective use information, and extracts a factor related to the user characteristic with respect to a usage rate of a predetermined product from among the selective use targets and the pieces of attribute information.

Other aspects of the present invention include a method comprising the aforementioned steps, and a non-transitory computer readable recording medium storing instructions that cause a computer to execute the aforementioned methods.

The disclosed information processing device generates data for accurately finding the characteristics of customer candidates in order to realize effective marketing in the medical field.

### BRIEF DESCRIPTION OF THE DRAWINGS

FIG. 1 is a diagram for explaining an outline of an information processing device according to the present embodiment.

FIG. 2 is a functional block diagram of the information processing device according to the embodiment.

FIG. 3 is a diagram showing an example of a user behavior information storing unit according to the present embodiment.

FIG. 4 is a diagram illustrating an example of user attribute information storing unit according to the present embodiment.

FIG. 5 is a diagram for explaining processing by a factor analysis processing unit according to the present embodiment;

FIG. 6 is a diagram showing an example of user integrated information generating unit according to the present embodiment.

FIG. 7 is a diagram showing a hardware configuration example of the information processing device according to the present embodiment.

FIG. 8 is a flowchart showing a flow of a processing example (part 1) by the information processing device according to the present embodiment.

FIG. 9 is a flowchart showing a flow of a processing example (part 2) by the information processing device according to the present embodiment.

FIG. 10 is a functional block diagram of the information processing device according to the second embodiment.

FIG. 11 is a diagram showing an example of factor extraction unit according to the second embodiment of the present invention;

FIG. 12 is a flowchart showing a flow of a processing example by the information processing device according to the second exemplary embodiment;

### DETAILED DESCRIPTION OF EMBODIMENTS

Embodiments of the present invention will be described with reference to the drawings.

### (Operation Principle of Information Processing Device According to Present Embodiment)

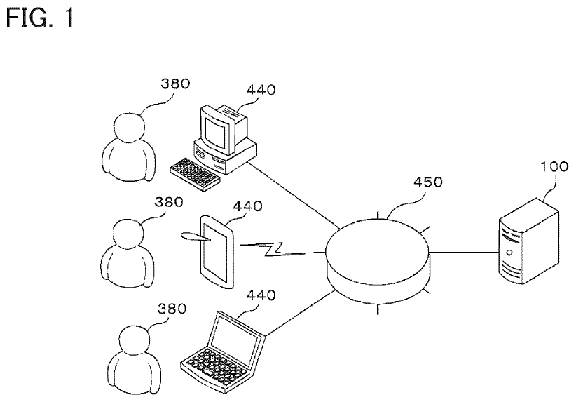

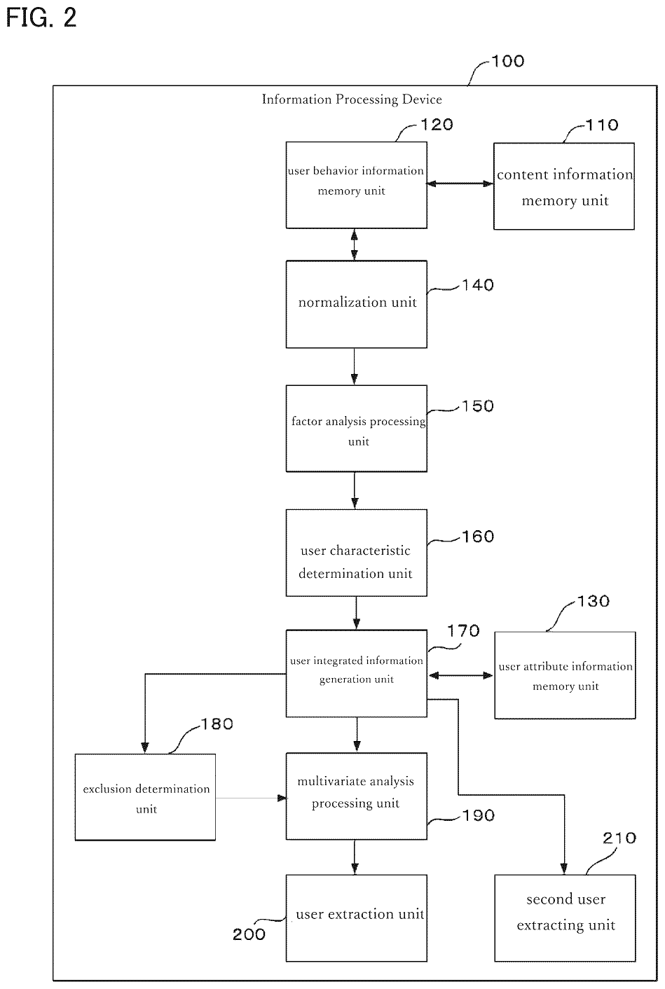

An operation principle of an information processing device (hereinafter, simply referred to as “the present device”) 100 according to the present embodiment will be described with reference to FIGS. 1 to 6. FIG. 1 is a diagram illustrating a connection relation between the present device 100 and other devices, and FIG. 2 is a functional block diagram of the present device 100.

As shown in FIG. 1, the present device 100 is connected to a user terminal 440 operated by a user 380 via a communication network 450. The communication network 450 may be wired or wireless. The user terminal 440 may be a personal computer of a desktop type or a laptop type, or a portable information terminal such as a smartphone.

As shown in FIG. 2, the present device 100 includes a content information memory unit (or content information memory) 110, a user behavior information storing unit (or user behavior information storage) 120, a user attribute information storing unit (or user attribute information storage) 130, a normalization unit 140, a factor analysis processing unit 150, a user characteristic determination unit 160, a user integrated information generating unit 170, an exclusion determination unit 180, a multivariate analysis processing unit 190, a user extraction unit 200, and a second user extraction unit 210. Among them, the content information memory unit 110, the user behavior information storing unit 120, and user attribute information storing unit 130 may be implemented by at least one of a ROM (Read-Only Memory) 520, a RAM (Random Access Memory) 530, and an auxiliary storage device 540 described later. The normalization unit 140, the factor analysis processing unit 150, the user characteristic determination unit 160, the user integrated information generating unit 170, the exclusion determination unit 180, the multivariate analysis processing unit 190, the user extraction unit 200, and the second user extraction unit 210 may be implemented by a CPU (Central Processing Unit) 510 described later.

The content information memory unit 110 stores content information (or medical content information) 310 related to medical treatment (particularly, cardiovascular internal medicine) that can be viewed and browsed on the Web site and tag information 320 for classifying the content information 310 based on the substance in association with each other, The content information 310 may be a text article or a moving image article.

In addition, the tag information 320 may be, for example, acute coronary syndrome, arrhythmia, literature, complicated PCI (Percutaneous Coronary Intervention), peripheral intravascular therapy, coronary flow reserve, guidelines, heart failure, ischemic heart disease, diagnostic imaging, live, drug therapy, academic society, structural heart disease, study overseas, medical management, and the like, and is content related to cardiovascular internal medicine. The tag information 320 can be changed, added, and deleted.

The user behavior information storing unit 120 stores user behavior information 400 that associates the user identification information 390, the tag information 320 corresponding to the content information 310 viewed or browsed by the user 380 identified by the user identification information 390, and the number of times of viewing or browsing 330 for each tag information 320. The number of times of viewing or browsing 330 may be the number of times of access by the user terminal 440 or the amount of time of viewing or browsing.

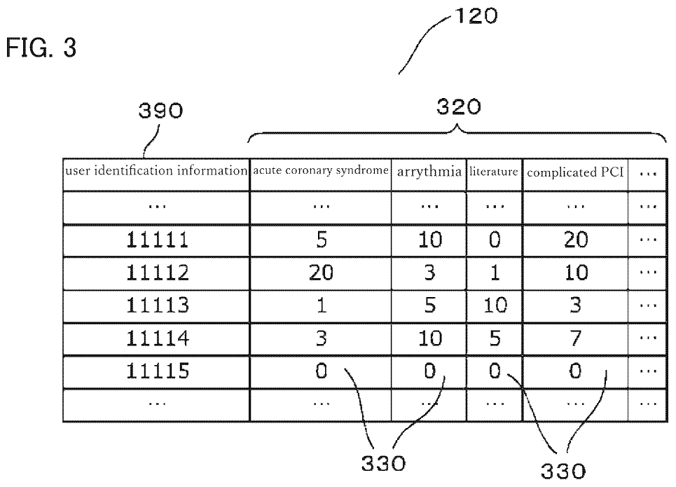

FIG. 3 is a diagram showing an example of the user behavior information storing unit 120. As shown in FIG. 3, the user behavior information storing unit 120 stores, for example, user behavior information 390 that associates (tag information 320, number of times of viewing or browsing 330)=(acute coronary syndrome, 5 times), (arrhythmia, 10 times), . . . for user identification information 390: 11111.

The user behavior information storing unit 120 stores, for example, user behavior information 400 relating (tag information 320, number of times of viewing or browsing 330)=(acute coronary syndrome, 0 times), (arrhythmia, 0 times), . . . to the user identification information 390:11115.

The user attribute information storing unit 130 stores user attribute information 410 associating the user identification information 390 with attribute information 350 including information (or viewing/browsing situation information) 340 relating to the viewing or browsing situation of the specific content information 310 of each user 380.

The attribute information 350 is information related to, for example, a workplace location, an age, a gender, a member type, a registration situation of a mail magazine, whether or not a person is a medical specialist of an academic society, whether or not a person is a certified doctor of an academic society, a participation situation in an event, a viewing/browsing situation of an article (which may be either a moving image article or a text article), and the like.

The information 340 relating to the viewing or browsing situation regarding the specific content information 310 is information relating to the presence or absence of viewing or browsing of the specific content information 310, the amount of time or number of times of viewing or browsing the specific content information 310, etc.

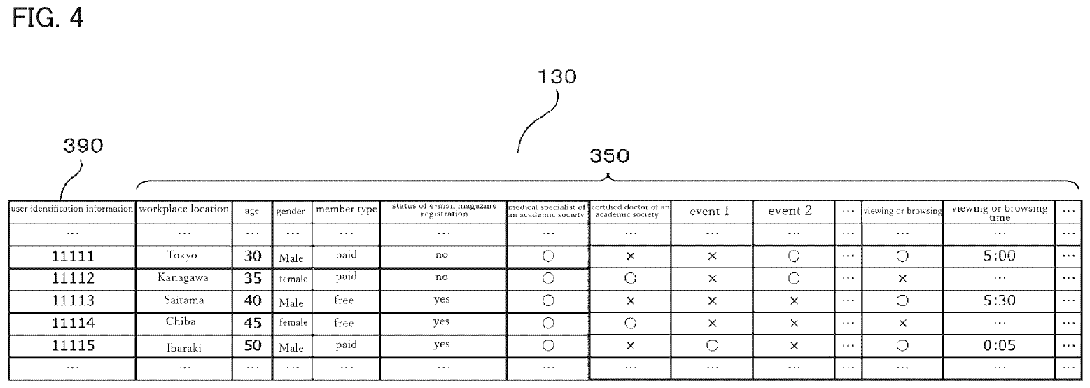

FIG. 4 is a diagram illustrating an example of the user attribute information storing unit 130. As illustrated in FIG. 4, the user attribute information storing unit 130 stores, for example, the user attribute information 410 in which, for the user identification information 390: 11111, the workplace location: Tokyo (metropolitan), the age: 30 (years old), the gender: male, the member type: paid member, the presence or absence of viewing or browsing of the specific content information 310: present, the amount of time of viewing or browsing of the specific content information 310: 5 minutes and 0 seconds, and etc. are associated.

In addition, the user attribute information storing unit 130 stores the user attribute information 410 in which, for example, for the user identification information 390: 11112, the location of the place of work: Kanagawa (prefecture), the age: 35 (years old), the gender: female, the member type: paid member, . . . , the presence or absence of viewing or browsing of the specific content information 310: none, the time of viewing or browsing of the specific content information 310: 0 seconds, . . . are associated.

The normalization unit 140 normalizes the number of times of viewing or browsing 330 for each piece of tag information 320 stored in the user behavior information storing unit 120 so as to represent the frequency of viewing or browsing by the user 380. The normalization method by the normalization unit 140 performs normalization by, for example, dividing the number of times of viewing or browsing 330 by the number of pieces of all content information 310.

Regarding the user identification information 390: 11111 in FIG. 3, for example, when the number of all the content information 310 is 500, the normalization unit 140 performs normalization such as acute coronary syndrome: 5÷500=0.01, arrhythmia: 10÷500=0.02, literature: 0÷500=0, and complicated PCI: 20÷500=0.04.

The factor analysis processing unit 150 applies a factor analysis process to the normalized user behavior information 400 to calculate a predetermined number of common factors 360. The number of common factors 360 calculated by the factor analysis process is not particularly limited.

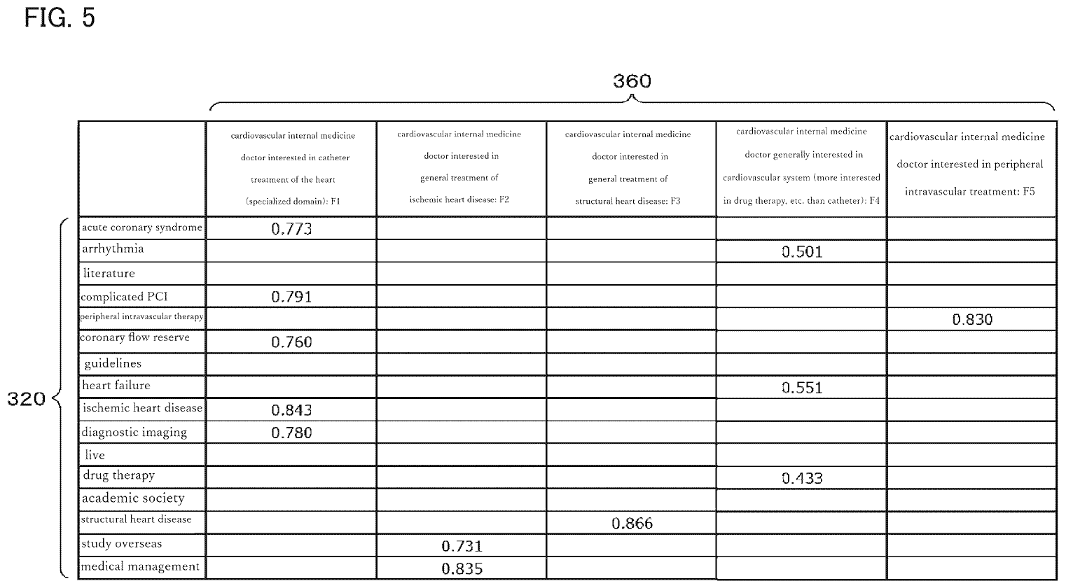

FIG. 5 is a diagram for explaining the processing by the factor analysis processing unit 150, and is a diagram schematically showing a factor loading amount obtained by the factor analysis processing. In FIG. 5, common factors 360 are taken in the horizontal direction, and tag information 320 is taken in the vertical direction. As shown in FIG. 5, the factor analysis processing unit 150 calculates, for example, five common factors 360, and defines the contents shown (expressed) by the common factors 360 based on the tag information 320 showing a relatively large value in the factor loading amount relating to each common factor 360 and the common sense of the medical industry.

The user characteristic determination unit 160 calculates a factor score 370 based on a predetermined number of common factors 360 calculated by the factor analysis processing unit 150 for each user identification information 390 for the normalized user behavior information 400. Then, the user characteristic determination unit 160 determines one common factor 360 having the highest score as the user characteristic 420 representing the feature of the user 380 identified by the user identification information 400.

As shown in FIG. 5, the content of the user characteristics 420 may be, for example, “a cardiovascular internal medicine doctor interested in catheter treatment of the heart (specialized domain): F1”, “a cardiovascular internal medicine doctor interested in general treatment of ischemic heart disease: F2”, “a cardiovascular internal medicine doctor interested in general treatment of structural heart disease: F3”, “a cardiovascular internal medicine doctor generally interested in cardiovascular system (more interested in drug therapy, etc. than catheter): F4”, and “a cardiovascular internal medicine doctor interested in peripheral intravascular treatment: F5”.

The user integrated information generating unit 170 integrates the normalized user behavior information 400, the user attribute information 410, and the user characteristic 420 based on the user identification information 390. Thereby, the user integrated information generating unit 170 generates the user integrated information 430 for performing attribution analysis by multivariate analysis of an event that the specific content information 310 satisfies a predetermined viewing or browsing situation.

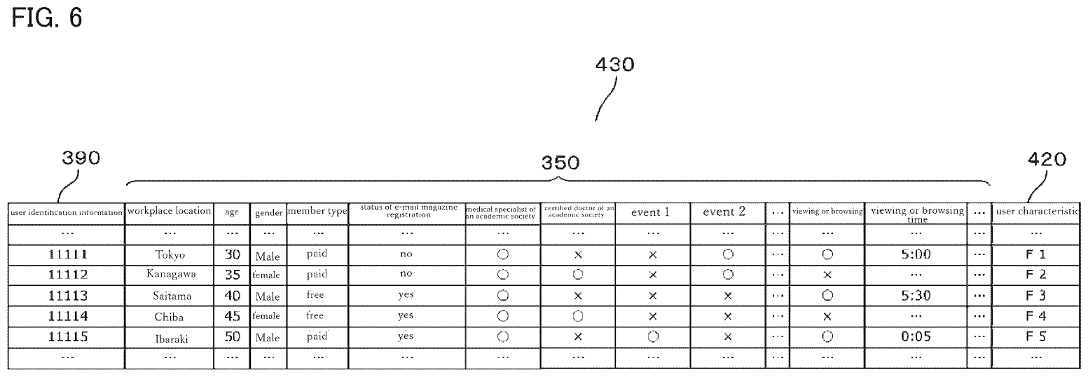

FIG. 6 is a diagram illustrating an example of the user integrated information generating unit 170. As shown in FIG. 6, the user integrated information generating unit 170 integrates the user property information 410 of FIG. 4 and the user characteristic 420 determined by the user characteristic determination unit 160 based on the user identification information 390. The user integrated information generating unit 170 generates the user integrated information 430 in which, for example, for the user identification information 390: 11111, the workplace location: Tokyo (metropolitan), the age: 30 (years old), the gender: male, the member type: paid member . . . , and the user characteristic 420: F1 are associated.

When the attribute information 350 includes information on the time when the specific content information 310 is viewed or browsed, the exclusion determination unit 180 determines whether or not to exclude each piece of user attribute information 410 from the processing target of the present device 100 based on the length of the viewing or browsing time for the specific content information 310.

For example, when the viewing or browsing time of the specific content information 310 is shorter or longer than a predetermined time, the exclusion determination unit 180 determines that the user attribute information 410 is excluded from the processing target of the present device 100. When the viewing or browsing time of the content information 310 is extremely short or long, it is determined that the user 380 is interested and is not viewing or browsing the content information 310, and it is determined to be excluded from the processing target of the present device 100. The accuracy and reliability of the analysis result by the present device 100 are improved by the processing by the exclusion determination unit 180.

As shown in FIG. 4, for example, the exclusion determination unit 180 determines that the user attribute information 410 in which the user identification information 390 is “11111” or “11113” is the processing target of the present device 100 because the viewing or browsing time is “5 minutes” and “5 minutes and 30 seconds”, respectively. On the other hand, the exclusion determination unit 180 determines that the user attribute information 410 in which the user identification information 390 is “11115” is excluded from the processing target of the present device 100 because the viewing or browsing time is extremely short, for example, “5 seconds”. The threshold value of the determination by the exclusion determination unit 180 can be appropriately determined.

Regarding the user integrated information 430, the multivariate analysis processing unit 190 specifies the items of the attribute information 350 that contribute to the event of satisfying a predetermined viewing or browsing situation with respect to the specific content information 310 by multivariate analysis processing. It is assumed that the event of satisfying the predetermined viewing or browsing situation is that the specific content information 310 is viewed or browsed, the specific content information 310 is viewed or browsed to the end, and the time of viewing or browsing the specific content information 310 is longer than a predetermined time, but the event is not limited to these.

As shown in FIG. 6, the multivariate analysis processing unit 190 performs, for example, multivariate analysis processing on the user integrated information 430, and specifies that the member type is paid, the e-mail magazine registration situation is available, etc., as items of the attribute information 350 that greatly contribute to viewing or browsing the specific content information 310.

The user extraction unit 200 extracts the user identification information 390 having the predetermined user characteristics 420 and satisfying the condition related to the attribute information 350 specified by the multivariate analysis processing unit 190 based on the user integrated information 430. By this processing, it is possible to effectively narrow down the targets for issuing the event participation guidance and the targets for placing the advertisement.

As shown in FIG. 6, for example, when “member type: paid” is specified by the multivariate analysis processing unit 190 and the predetermined user characteristic 420 is “F1”, the user extraction unit 200 extracts “11111” as the user identification information 390. On the other hand, for example, when “member type: paid” is specified by the multivariate analysis processing unit 190 and the predetermined user characteristic 420 is “F2”, the user extraction unit 200 extracts “11112” as the user identification information 390.

The second user extraction unit 210 extracts the user identification information 390 having the predetermined user characteristics 420 and satisfying the predetermined viewing or browsing situation with respect to the specific content information 310, based on the user integrated information 430. It is assumed that the predetermined viewing or browsing situation is satisfied when the specific content information 310 is viewed or browsed, when the specific content information 310 is viewed or browsed to the end, when the time of viewing or browsing the specific content information 310 is longer than the predetermined time, and the like, but the present invention is not limited to these. By this processing, it is possible to effectively narrow down the targets for which the event participation guidance is issued and the targets for which the advertisement is placed.

In FIG. 6, for example, when the predetermined viewing or browsing situation is “viewed or browsed” and the predetermined user characteristic 420 is “F5”, the second user extraction unit 210 extracts “11115” as the user identification information 390.

As shown in FIG. 6, it is assumed that the attribute information 350 includes information relating to the time of viewing or browsing the specific content information 310. In this case, the second user extraction unit 210 may extract the user identification information 390 for identifying the user 380 who has a predetermined user characteristic 420 and has viewed or browsed the specific content information 310 for a time longer than the predetermined time based on the user integrated information 430. It is estimated that the user 380 who has viewed or browsed the specific content information 310 for a long time has a deep interest in the specific content information 310, and an effective marketing activity can be performed by setting such a user 380 as an object to which an event participation guidance is issued or an object to which an advertisement is placed.

As shown in FIG. 6, for example, when the predetermined viewing or browsing situation is “viewing or browsing time is 5 minutes or more” and the predetermined user characteristic 420 is “F1”, the second user extraction unit 210 extracts “11111” as the user identification information 390.

The device 100 generates data for accurately finding characteristics of customer candidates in order to realize effective marketing in the medical field, based on the operation principle as described above.

Further, based on the operation principle as described above, the present device 100 can accurately extract a customer candidate having a high reaction rate in order to realize effective marketing in the medical field.

### (Hardware Configuration of Information Processing Device According to Present Embodiment)

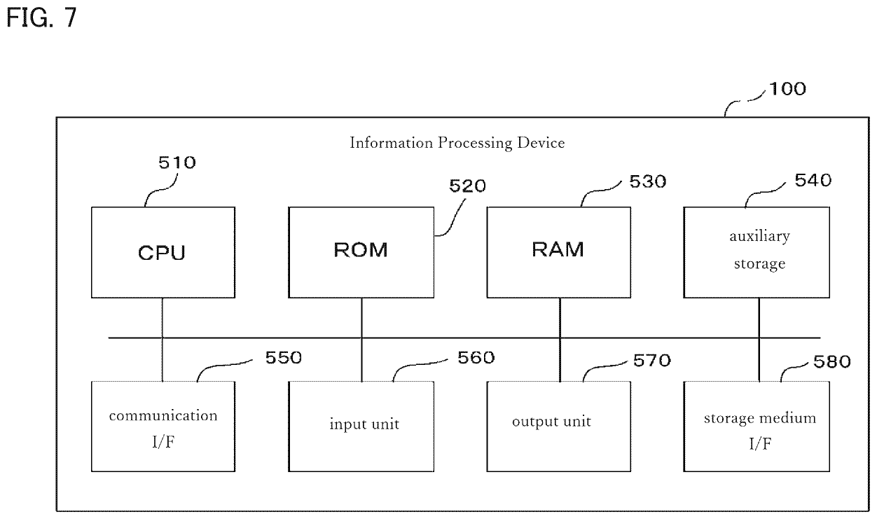

An example of a hardware configuration of the present device 100 will be described with reference to FIG. 7. FIG. 7 is a diagram showing an example of a hardware configuration of the present device 100. As shown in FIG. 7, the present device 100 includes a hardware processor including the CPU 510, the ROM 520, the RAM 530, the auxiliary storage device 540, a communication I/F 550, an input unit 560, a display device 570, and a storage medium I/F 580.

The CPU 510 is a device for executing instructions such as a program stored in the ROM 520, and performs arithmetic processing on data expanded (loaded) in the RAM 530 according to the instructions to control the entire device 100. The ROM 520 stores instructions and data to be executed by the CPU 510. When the CPU 510 executes the instructions stored in the ROM 520, the RAM 530 expands (loads) the instructions and data to be executed, and temporarily holds the operation data during the operation.

The auxiliary storage device 540 is a device for storing an OS (Operating System) as basic software, instructions such as an application program according to the present embodiment, and the like together with related data. The auxiliary storage device 540 is, for example, an HDD (Hard Disk Drive), a flash memory, or the like.

The communication I/F 550 is an interface for transmitting and receiving data to and from another device that is connected to a communication network 450 such as a wired or wireless LAN (Local Area Network) or the Internet and provides a communication function.

An input unit 560 is a device for inputting data to the present device 100, such as a keyboard. A display device (output device) 570 is a device configured by an LCD (Liquid Crystal Display) or the like, and functions as a user interface when a user uses functions of the present device 100 or performs various settings. A storage medium I/F 580 is an interface for transmitting and receiving data to and from a storage medium 590 such as a CD-ROM, a DVD-ROM, or a USB memory.

Each unit included in the present device 100 may be realized by the CPU 510 executing the instructions corresponding to respective units stored in the ROM 520 or the auxiliary storage device 540. In addition, each unit included in the present device 100 may be realized by processing related to each unit as hardware. In addition, the instructions according to the present invention may be read from an external server device via the communication I/F 550, or the instructions according to the present invention may be read from the storage medium 590 via the storage medium I/F 580, and the present device 100 may execute the instructions.

### (Example of Processing by Information Processing Device According to Present Embodiment)

### (1) Processing Example (No. 1) by Present Device 100

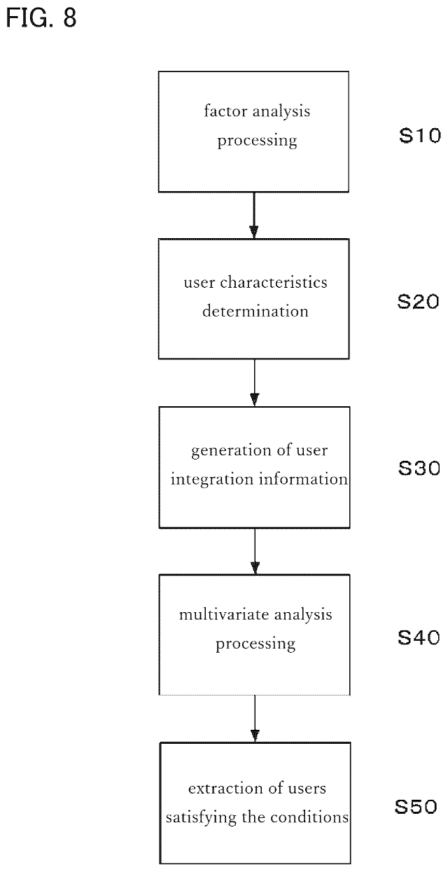

A processing example (part 1) by the present device 100 will be described with reference to FIG. 8. FIG. 8 is a flowchart showing a flow of a processing example (part 1) by the present device 100.

In S10, the normalization unit 140 normalizes the number of times of viewing or browsing 330 for each piece of tag information 320 stored in the user behavior information storing unit 120 so as to represent the frequency of viewing or browsing by the user 380. The normalization method by the normalization unit 140 performs normalization by, for example, dividing the number of times of viewing or browsing 330 by the number of pieces of all pieces of content information 310.

For the user identification information 390: 11111 in FIG. 3, for example, when the number of all the content information 310 is 500, the normalization unit 140 performs normalization such as acute coronary syndrome: 5÷500=0.01, arrhythmia: 10÷500=0.02, literature: 0÷500=0, complicated PCI: 20÷500=0.04, and the like.

Further, the factor analysis processing unit 150 in the S10 applies the factor analysis processing to the normalized user behavior information 400 to calculate a predetermined number of common factors 360. The number of common factors 360 calculated by the factor analysis processing is not particularly limited.

As shown in FIG. 5, the factor analysis processing unit 150 calculates, for example, five common factors 360, and defines the content indicated (represented) by each common factor 360 based on the tag information 320 indicating a relatively large value in the factor load amount relating to each common factor 360 and the common sense of the medical industry.

In S20, the user characteristic determination unit 160 calculates a factor score 370 based on a predetermined number of common factors 360 calculated by the factor analysis processing unit 150 for each user identification information 390 with respect to the normalized user behavior information 400, and the user characteristic determination unit 160 determines one common factor 360 having the highest score as the user characteristic 420 representing the feature of the user 380 identified by the user identification information 400.

As shown in FIG. 5, the content of the user characteristics 420 may be, for example, “a cardiovascular internal medicine doctor interested in catheter treatment of the heart (specialized domain): F1”, “a cardiovascular internal medicine doctor interested in general treatment of ischemic heart disease: F2”, “a cardiovascular internal medicine doctor interested in general treatment of structural heart disease: F3”, “a cardiovascular internal medicine doctor interested in cardiovascular system (interested in drug therapy, etc. rather than catheter): F4”, and “a cardiovascular internal medicine doctor interested in peripheral intravascular treatment: F5”.

In S30, the user integrated information generating unit 170 integrates the normalized user behavior information 400, the user attribute information 410, and the user characteristic 420 based on the user identification information 390. Thereby, the user integrated information generating unit 170 generates the user integrated information 430 for performing attribution analysis by multivariate analysis of an event that the specific content information 310 satisfies a predetermined viewing or browsing situation.

As shown in FIG. 6, the user integrated information generating unit 170 integrates the user attribute information 410 of FIG. 4 and the user characteristic 420 determined by the user characteristic determination unit 160 based on the user identification information 390. The user integrated information generating unit 170 generates, for example, the user integrated information 430 that associates the user identification information 390: 11111 with the working location: Tokyo (metropolitan), the age: 30 (years old), the gender: male, the member type: paid member, . . . , the user characteristic 420: F1.

Furthermore, in S30, when the attribute information 350 includes information on the time when the specific content information 310 is viewed or browsed, the exclusion determination unit 180 determines whether or not to exclude each piece of user attribute information 410 from the processing target of the present device 100 based on the length of the viewing or browsing time for the specific content information 310.

For example, when the viewing or browsing time of the specific content information 310 is shorter or longer than a predetermined time, the exclusion determination unit 180 determines that the user attribute information 410 is excluded from the processing target of the present device 100. When the viewing or browsing time of the content information 310 is extremely short or long, it is determined that the user 380 is interested and is not viewing or browsing the content information 310, and it is determined to be excluded from the processing target of the present device 100. The accuracy and reliability of the analysis result by the present device 100 are improved by the processing by the exclusion determination unit 180.

As shown in FIG. 4, for example, the exclusion determination unit 180 determines that the user attribute information 410 in which the user identification information 390 is “11111” or “11113” is the processing target of the present device 100 because the viewing or browsing time is “5 minutes” and “5 minutes and 30 seconds”, respectively. On the other hand, the exclusion determination unit 180 determines that the user attribute information 410 in which the user identification information 390 is “11115” is excluded from the processing target of the present device 100 because the viewing or browsing time is extremely short, for example, “5 seconds”. The threshold value of the determination by the exclusion determination unit 180 can be appropriately determined.

In S40, with respect to the user integrated information 430, the multivariate analysis processing unit 190 specifies the items of the attribute information 350 contributing to the event of satisfying the predetermined viewing or browsing situation with respect to the specific content information 310 by the multivariate analysis processing.

As shown in FIG. 6, the multivariate analysis processing unit 190 performs, for example, multivariate analysis processing on the user integrated information 430, and specifies that the member type is paid, the e-mail magazine registration situation is available, etc., as items of the attribute information 350 that greatly contribute to viewing or browsing the specific content information 310.

In S50, the user extraction unit 200 extracts the user identification information 390 that has a predetermined user characteristic 420 based on the user integrated information 430 and satisfies the condition related to the attribute information 350 specified by the multivariate analysis processing unit 190. By this processing, it is possible to effectively narrow down the objects to which the participation guidance of the event is issued and the objects to which the advertisement is placed.

As shown in FIG. 6, for example, when “member type: paid” is specified by the multivariate analysis processing unit 190 and the predetermined user characteristic 420 is “F1”, the user extraction unit 200 extracts “11111” as the user identification information 390. On the other hand, for example, when “member type: paid” is specified by the multivariate analysis processing unit 190 and the predetermined user characteristic 420 is “F2”, the user extraction unit 200 extracts “11112” as the user identification information 390.

By performing the processing as described above, the present device 100 generates the data for accurately finding out the feature of the customer candidate in order to realize effective marketing in the medical field.

In addition, by performing the process as described above, the present device 100 can accurately extract a customer candidate having a high reaction rate in order to realize effective marketing in the medical field.

### (2) Processing Example (No. 2) by Present Device 100

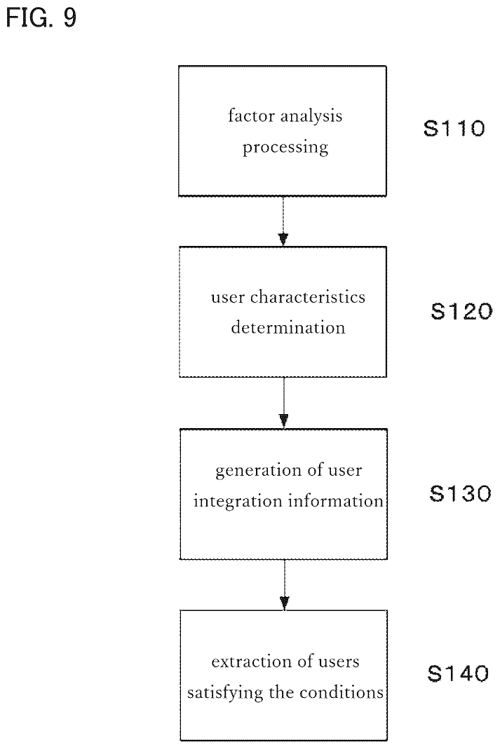

A processing example (part 2) by the present device 100 will be described with reference to FIG. 9. FIG. 9 is a flowchart showing a flow of a processing example (part 2) by the present device 100.

It should be noted that, since S110 to S130 are the same as the processing in S10 to S30, the description is omitted here. Hereinafter, the processing after the processing in S110 to S130 (S10 to S30) is performed will be described.

In the S140, the second user extraction unit 210 extracts the user identification information 390 that has the predetermined user characteristic 420 and satisfies the predetermined viewing or browsing situation with respect to the specific content information 310 based on the user integrated information 430. By this processing, it is possible to effectively narrow down a target to which a guide to participate in an event is given, a target to which an advertisement is placed, and the like.

In FIG. 6, for example, when the predetermined viewing or browsing situation is “viewing or browsing” and the predetermined user characteristic 420 is “F5”, the second user extraction unit 210 extracts “11115” as the user identification information 390.

As shown in FIG. 6, it is assumed that the attribute information 350 includes information relating to the amount of time of viewing or browsing the specific content information 310. In this case, the second user extraction unit 210 may extract the user identification information 390 for identifying the user 380 who has a predetermined user characteristic 420 and has viewed or browsed the specific content information 310 for a longer time than the predetermined time based on the user integrated information 430. It is estimated that the user 380 who has viewed or browsed the specific content information 310 for a long time has a deep interest in the specific content information 310, and an effective marketing activity can be performed by setting such a user 380 as an object to which an event participation guidance is issued or an object to which an advertisement is placed.

As shown in FIG. 6, for example, when the predetermined viewing or browsing situation is “viewing or browsing time is 5 minutes or more” and the predetermined user characteristic 420 is “F1”, the second user extraction unit 210 extracts “11111” as the user identification information 390.

By performing the processing as described above, the present device 100 generates the data for accurately finding out the feature of the customer candidate in order to realize effective marketing in the medical field.

In addition, by performing the process as described above, the present device 100 can accurately extract a customer candidate having a high reaction rate in order to realize effective marketing in the medical field.

Next, an information processing device according to the second embodiment of the present embodiment will be described. An information processing device (hereinafter, simply referred to as “the device”) 600 according to the second embodiment of the present embodiment is different from the above-described embodiment (hereinafter, sometimes referred to as “the above mentioned first embodiment”) in the processing after the determination of the user characteristic by the user characteristic determining unit 160. The same components as those of the above mentioned first embodiment are denoted by the same reference numerals, and the description thereof will be omitted.

### (Principle of Operation of Information Processing Device According to Second Embodiment)

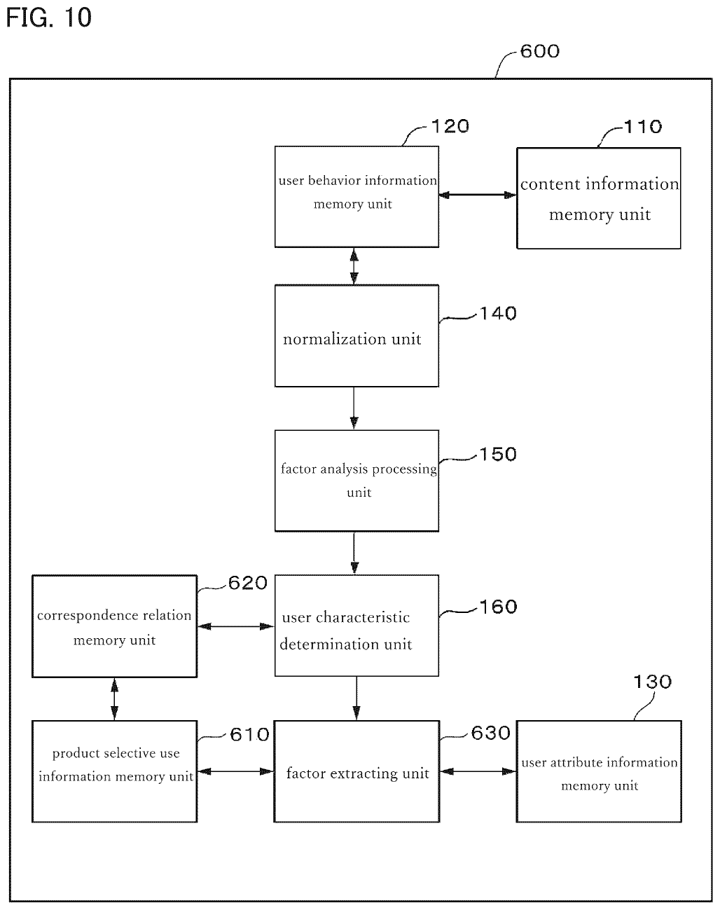

An operation principle of the device 600 will be described with reference to FIG. 10. FIG. 10 is a functional block diagram of the device 600.

Similar to the above mentioned first embodiment, the device 600 is connected to a user terminal 440 operated by a user 380 via a communication network 450. The device 600 has a CPU510, a ROM520, a RAM530, an auxiliary storage device 540, a communication I/F 550, an input unit 560, a display device 570, and a storage medium I/F 580.

As shown in FIG. 10, the present device 600 includes a content information memory unit (or content information memory) 110, a user behavior information storing unit (or user behavior information storage) 120, a user attribute information storing unit (or user attribute information storage) 130, a normalization unit 140, a factor analysis processing unit 150, a user characteristic determination unit 160, a product selective use information memory unit (or product selective use information memory) 610, a correspondence relation memory unit (or correspondence relation memory) 620, and a factor extraction unit 630. Among them, the content information memory unit 110, the user behavior information storing unit 120, the user attribute information storing unit 130, the product selective use information memory unit 610, and the correspondence relation memory unit 620 may be implemented by at least one of the ROM 520, the RAM 530, and the auxiliary storage device 540. The normalization unit 140, the factor analysis processing unit 150, the user characteristic determination unit 160, and the factor extraction unit 630 may be implemented by the CPU510.

The product selective use information memory unit 610 stores product selective use information that associates the user identification information 390, the plurality of pieces of attribute information 350 of the user identified by the user identification information 390, and the selective use information for the plurality of selective use targets of the plurality of products related to medical treatment having the same effect used by the user identified by the user identification information 390. The products related to medical treatment include pharmaceutical products and medical equipment. In the following description, “pharmaceutical products” are described as examples of products related to medical treatment. In the following description, “products related to medical treatment” may be simply referred to as “products”.

The plurality of pieces of attribute information 350 of the user is information stored in the user attribute information storing unit 130, and includes information on various attributes of the user such as the number of times of execution of a predetermined surgery or the like and the number of times of information provision from a medical Representative (MR), in addition to the above-described workplace location, age, gender, member type, mail magazine registration situation, whether or not the user is an medical specialist of academic societies, whether or not the user is an academic society-certified doctor, participation situation in an event, and viewing/listening situation of an article.

“A plurality of products for medical use having the same effect”, for example, in the case of a “pharmaceutical product”, unit drugs of the same type and the same effect having the same efficacy and effect and medicinal efficacy and pharmacology, although the pharmaceutical company as the manufacturer and the product name are different. In the case of a “medical device”, it unit a medical device having the same function, although the pharmaceutical company as the manufacturer and the medical device manufacturer and distributor and the product name are different. That is, “the same effect” does not mean exactly the same effect. For example, a plurality of direct anti-coagulants (DOACs) distributed in the market by a plurality of pharmaceutical companies are a plurality of products (pharmaceutical products) for medical use having “the same effect” of suppressing the action of various coagulation factors that solidify blood and preventing thrombosis caused by stagnation of blood in blood vessels with slow blood flow. In the following, the case where the pharmaceutical product is a “direct anti-coagulant” will be described, but the pharmaceutical product is not limited to the “direct anti-coagulant”, and may correspond to “a plurality of pharmaceutical products having the same effect”.

The “plurality of targets for selective use” is information on targets (patients) for selective use of a plurality of products (medicines) For example, in the direct anticoagulant (DOAC), the plurality of targets for selective use may be “patients with chronic kidney disease (CKD)”, “patients with liver disease”, “patients with diabetes”, “patients after lower limb revascularization”, “patients after transcatheter aortic valve replacement (TAVI)”, “patients with deep vein thrombosis”, “patients with pulmonary embolism”, “patients with high bleeding tendency”, “elderly people”, “young people”, “patients with dementia”, and the like.

That is, the “selective use information” is information on how the user selectively uses a plurality of products having the same effect for various selective use targets. For example, the user X uses the drug A for “patients with a high bleeding tendency”, the drug B for “patients after lower limb revascularization”, and the drug C for “demented patients” with respect to the drugs A, B, and C having the same effect. The “selective use information” can be acquired, for example, by performing a questionnaire with respect to a user of a Web site capable of viewing and browsing the content information 310 and so on. Specifically, a plurality of selective use targets of the direct anticoagulant are listed in advance in the questionnaire, and the user of the Web site is asked to answer which of the direct anticoagulants of a plurality of pharmaceutical companies is used for each of the selective use targets. The selective use targets can be changed, added, and deleted.

As described above, the “product selective use information” is information in which the user identification information 390, the plurality of pieces of attribute information 350 of the user, and the information on the selective use of the plurality of products for the plurality of selective use targets are associated (corresponding) with each other.

The correspondence relation memory unit 620 stores the correspondence relation between a plurality of selective use targets and a plurality of attribute information 350 and the user characteristics 420. For example, a predetermined number of common factors 360 when the factor analysis processing unit 150 applies the factor analysis processing are specified in advance, and the common factors 360 and the user characteristics 420 correspond to each other. Therefore, the correspondence relation memory unit 620 can store the correspondence relation between a plurality of selective use targets and a plurality of attribute information 350 and the user characteristics 420 by storing the correspondence relation between these common factors 360 and both of the plurality of selective use targets and the plurality of attribute information 350 in advance. For example, among the plurality of selective use targets, the user characteristic 420 of “cardiovascular internal medicine doctor interested in peripheral endovascular treatment: F5” is associated with “patient after lower extremity revascularization”. In addition, when the plurality of attribute information 350 includes “PCI (percutaneous coronary intervention (predetermined surgery))”, the user characteristic 420 of “cardiovascular internal medicine doctor interested in cardiac catheterization (specialized domain): F1” is associated. It should be noted that a plurality of one user characteristics 420 may be associated with one selective use target or attribute information 350.

The factor extraction unit 630 applies multivariate analysis based on the product selective use information, and extracts factors (hereinafter, referred to as “use rate factors”) related to the user characteristics 420 with respect to the use rate of a predetermined product from a plurality of selective use targets and a plurality of pieces of attribute information 350. In the present embodiment, an example in which the factor extraction unit 630 applies decision tree analysis will be described. The multivariate analysis is not limited to the decision tree analysis, and may be, for example, Cox regression proportional hazard analysis, multiple regression analysis, or the like.

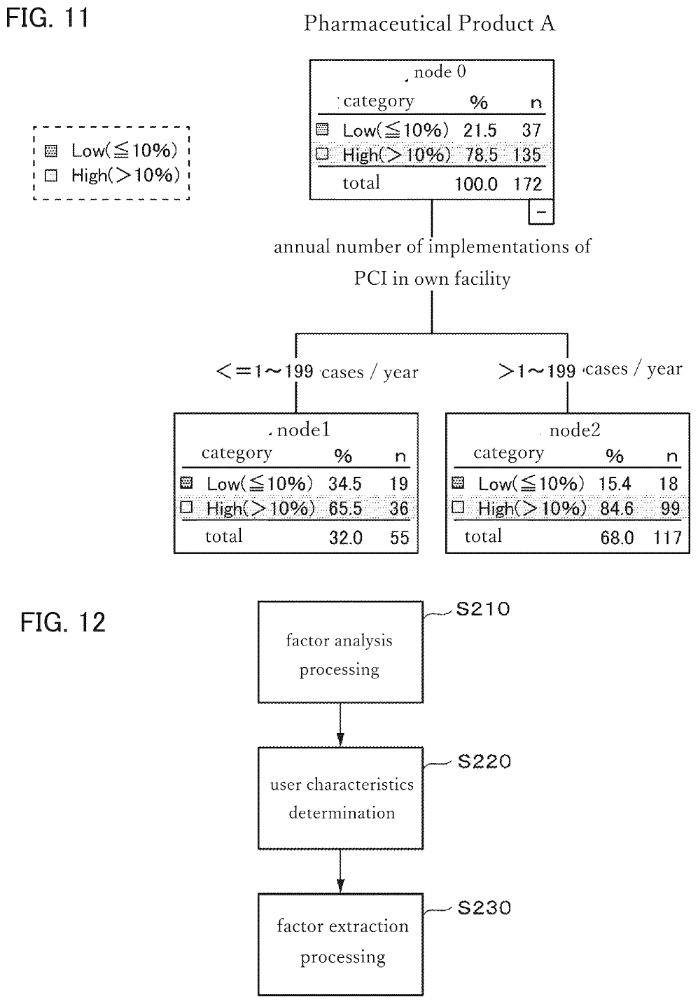

In the present embodiment, when the factor extraction unit 630 extracts the usage rate factor related to the user characteristic 420 from the plurality of selective use targets and the plurality of attribute information 350, first, all the users are divided into a top user whose usage rate of the target product (for example, “pharmaceutical product A”) is equal to or higher than a predetermined value (for example, 10% or higher) and a bottom user whose usage rate is lower than the predetermined value (for example, under 10%). Then, the factor extraction unit 630 executes multivariate analysis for the plurality of selective use targets and the plurality of attribute information 350 based on the product selective use information, and extracts the usage rate factor related to the user characteristic 420 with respect to the usage rate of the pharmaceutical product A. The usage rate factor related to the user characteristic 420 indicates what kind of user characteristic 420 is related as a factor of the high (or low) usage rate of the pharmaceutical product A. The predetermined value is not limited to 10%. FIG. 11 is a diagram illustrating an example of the factor extraction unit according to the second embodiment of the present embodiment.

As shown in FIG. 11, the factor extraction unit 630 applies (executes) multivariate analysis (decision tree analysis in the present embodiment) to a plurality of selective use targets and a plurality of attribute information 350 based on the product selective use information, and extracts use rate factors related to the user characteristic 420 with respect to the usage rate of the pharmaceutical product A. In FIG. 11, in the pharmaceutical product A, since there are 99 top users in the “node 2” where the annual number of PCI (percutaneous coronary intervention) performed is large and there are many users with a high usage rate, the “annual number of PCI performed” is extracted as a factor of the high usage rate of the pharmaceutical product A. In the user characteristic 420 corresponding to “PCI”, “cardiovascular internal medicine doctor (specialized domain) interested in cardiac catheterization: F1” is associated with the correspondence stored in the correspondence memory unit 620. As a result of this, the user characteristic 420 (F1) is extracted as a factor of the high usage rate of the pharmaceutical product A. In the present embodiment, the decision tree analysis for one item (“annual number of PCI performed”) is applied (see FIG. 11), but the decision tree analysis for other items (selective use targets and attribute information 350) may be further applied to each of the “node 1” and the “node 2”. In FIG. 11, the “node 0” is branched into two nodes (“node 1” and “node 2”) based on the “annual number of PCI performed”, but the present invention is not limited thereto, and three or more nodes may be branched. In the present embodiment, the factor of the high usage rate of the pharmaceutical product A is extracted, but the factor of the low usage rate of the pharmaceutical product A may be extracted.

### (Processing Example by Information Processing Device According to Present Embodiment)

An example of processing by the device 600 will be described with reference to FIG. 12. FIG. 12 is a flowchart showing a flow of an example of processing by the information processing device according to the second embodiment of the present embodiment. Note that, since S210 and S220 are the same as the processing in S10 and S20 of the above mentioned first embodiment, the description is omitted here. Hereinafter, the processing after the processing in S210 and S220 (S10 and S20) is performed will be described.

In S230, the factor extraction unit 630 applies at least decision tree analysis based on the product selective use information, and extracts use rate factors related to the user characteristic 420 with respect to the usage rate of the predetermined product (medicine) from the plurality of selective use targets and the plurality of pieces of attribute information 350. For example, as shown in FIG. 11, the factor extraction unit 630 extracts the user characteristic 420 (F1) as a factor of the high usage rate of the medicine A. By this processing, it is possible to effectively narrow down the target for issuing the event participation guidance and the user segment (user characteristic 420) for placing the advertisement.

In the present device 600 configured as described above, since the user characteristic determining unit 160 determines the user characteristic 420 based on the normalized user behavior information 400, it can be determined whether or not the article of the Web site has reached a predetermined user segment (user characteristic 420) as a marketing target (whether or not the user is interested in the article).

For example, there is a case of a pharmaceutical company's targeting a predetermined user segment (user characteristics 420) as a marketing target and conduct sales to the user segment. Specifically, the pharmaceutical company may provide an advertisement article targeting the predetermined user segment (an article that the predetermined user segment is considered to be interested in) to a Web site as content information 310. The device 600 normalizes the user behavior information 400 based on the number of times of viewing or browsing 330, etc. for each piece of tag information 320 of the Web site, and determines the user characteristics 420 based on the normalized user behavior information 400. Then, by checking the access log, etc. of the article provided by the pharmaceutical company and checking the user characteristics 420 of the accessing user, it is possible to determine whether or not the article of the Web site has reached (is interested in) the predetermined user segment (user characteristics 420) targeted for marketing by the pharmaceutical company. As a result, it is possible to appropriately change the content of the article according to the determination result of the user characteristics 420 and enhance the advertisement effect on the desired user segment (user characteristics 420).

In addition, the cause extraction unit 630 extracts a usage rate cause related to the user characteristic 420 with respect to the usage rate of the predetermined product from among the plurality of targets for selective use and the plurality of pieces of attribute information 350 based on the product selective use information. Accordingly, it is possible to extract a user segment (the user characteristic 420) which is a cause of improving the usage rate of the product, and thus, the pharmaceutical company can determine whether a user segment which is a marketing target is a user segment which is a cause of actually improving the usage rate of the product. As a result, the marketing target can be clarified, and the marketing efficiency can be improved.

As described above, according to the present embodiment, it is possible to clearly narrow down the user segment (user characteristics 420) to be marketed, and it is possible to determine whether or not the advertisement has adequately reached the desired user segment (user characteristics 420).

By performing the processing as described above, the present device 600 can generate data for adequately finding out features of customer candidates in order to realize effective marketing in the medical field.

In addition, by performing the process as described above, the present device 600 can adequately extract a customer candidate having a high reaction rate in order to realize effective marketing in the medical field.

In addition to the above mentioned first embodiment and the second embodiment, other analyses may be performed. For example, in the second embodiment, information on selective use of a plurality of products having the same effect corresponding to “a plurality of selective use targets” is included in the information on selective use of products to be analyzed. The “a plurality of selective use targets” are information on targets (patients) for properly using a plurality of products, but in other analyses, other reasons (reasons other than patients) for properly using a plurality of products may be included in the information on selective use of products. As “other reasons”, for example, reasons such as “because it is a adopted drugs at the hospital where I work”, “because I obtained information at an academic meeting”, and “because I received opinions from my superiors and colleagues” can be mentioned. In this way, after including the “other reasons” in the information on selective use of products, the “other reasons” that are factors for improving the use rate of the products may be extracted by logistic regression analysis or the like.

In the present embodiment, the device 600 is not provided with the user integrated information generating unit 170, the exclusion determination unit 180, the multivariate analysis processing unit 190, the user extraction unit 200, and the second user extraction unit 210 of the above mentioned first embodiment, but these may be provided. That is, the device 600 may perform the processing executed by the factor extraction unit 630 in addition to all the processing of the above mentioned first embodiment. Furthermore, in addition to all the processing of the above mentioned first embodiment and the processing executed by the factor extraction unit 630 of the second embodiment, the above-mentioned other analysis (analysis including the above-mentioned “other reasons”) processing may be executed.

In the above mentioned first embodiment and the second embodiment, an example of the cardiovascular internal medicine among the medical diagnosis departments has been described, but the diagnosis department is not limited to the cardiovascular internal medicine, and can be applied to various diagnosis departments.

Although the embodiments of the present invention have been described in detail, the present invention is not limited to the specific embodiments, and various modifications and changes can be made within the scope of the gist of the present invention described in the claims.

### EXPLANATION OF SYMBOLS

100, 600 Information processing device
110 content information memory unit
120 user behavior information storing unit
130 user attribute information storing unit
140 normalization unit
150 factor analysis processing unit
160 user characteristic determination unit
170 user integrated information generating unit
180 exclusion determination unit
190 multivariate analysis processing unit
200 user extraction unit
210 second user extraction unit
310 content information
320 tag information
330 number of viewing or browsing times of content information
340 information related to viewing or browsing situation
350 attribute information
360 common factors by factor analysis processing
370 factor score based on common factors
380 users
390 user identification information
400 user behavior information
410 user attribute information
420 user characteristics
430 user integrated information
440 user terminal
450 communication network
510 CPU
520 ROM
530 RAM
540 auxiliary storage
550 communication I/F
560 input unit
570 output unit
580 storage medium I/F
590 storage medium
610 product selective use information memory unit
620 correspondence relation memory unit
630 factor extracting unit

What is claimed is:

1. An information processing device comprising:
a content information memory;
a user behavior information storage;
a user attribute information storage; and
a central processing unit (CPU) that:
stores, in the content information memory, medical content information viewable or browsable on a Web site and tag information classifying the medical content information to be associated with each other,
stores, in the user behavior information storage, user behavior information that associates user identification information, the tag information corresponding to the medical content information viewed or browsed by a user identified by the user identification information, and a number of times of viewing or browsing per the tag information with one another,
stores, in the user attribute information storage, user attribute information that associates the user identification information and attribute information including viewing/browsing situation information of the medical content information viewed or browsed by the user with each other,
normalizes the number of times of viewing or browsing per the tag information to represent a frequency of viewing or browsing by the user;
applies factor analysis processing to the user behavior information after the normalizing to calculate a predetermined number of common factors;
calculates a factor score of the user behavior information after the normalizing based on the predetermined number of common factors per the user identification information, and detects one of the common factors having a highest score as a user characteristic of the user identified by the user identification information;
integrates the user attribute information and the user characteristic based on the user identification information, and generates user integrated information used for attribute analysis by multivariate analysis of an event of satisfying a predetermined viewing or browsing situation with respect to the medical content information viewed or browsed by the user;
with respect to the user integrated information, identifies, by multivariate analysis, an item of the attribute information including the viewing/browsing situation information of the medical content information viewed or browsed by the user, the item of the attribute information contributing to the event of satisfying the predetermined viewing or browsing situation suggesting that the user is deeply interested in the medical content information viewed or browsed by the user; and
based on the user integrated information, extracts the user identification information having a predetermined user characteristics and satisfying a condition of the item of the attribute information that has been identified.

2. An information processing method for an information processing device that comprises: a content information memory; a user behavior information storage; and a user attribute information storage, the information processing method comprising:
storing, in the content information memory, medical content information viewable or browsable on a Web site and tag information classifying the medical content information to be associated with each other,
storing, in the user behavior information storage, user behavior information that associates user identification information, the tag information corresponding to the medical content information viewed or browsed by a user identified by the user identification information, and a number of times of viewing or browsing per the tag information with one another,
storing, in the user attribute information storage, user attribute information that associates the user identification information and attribute information including viewing/browsing situation information of the medical content information viewed or browsed by the user with each other,
normalizing the number of times of viewing or browsing per the tag information to represent a frequency of viewing or browsing by the user;
applying factor analysis processing to the user behavior information after the normalizing to calculate a predetermined number of common factors;
calculating a factor score of the user behavior information after the normalizing based on the predetermined number of common factors per the user identification information, and detecting one of the common factors having a highest score as a user characteristic of the user identified by the user identification information;
integrating the user attribute information and the user characteristics based on the user identification information, and generating user integrated information used for attribution analysis by multivariate analysis of an event of satisfying a predetermined viewing or browsing situation with respect to the medical content information viewed or browsed by the user;
with respect to the user integrated information, identifying, by multivariate analysis, an item of the attribute information including the viewing/browsing situation information of the medical content information viewed or browsed by the user, the item of the attribute information contributing to the event of satisfying the predetermined viewing or browsing situation suggesting that the user is deeply interested in the medical content information viewed or browsed by the user; and
based on the user integrated information, extracting, the user identification information having a predetermined user characteristic and satisfying a condition of the item of the attribute information that has been identified.

3. An information processing device comprising:
a content information memory;
a user behavior information storage;
a user attribute information storage;
a product selective use information memory;
a correspondence relation memory; and
a central processing unit (CPU) that:
stores, in the content information memory, medical content information viewable or browsable on a Web site and tag information classifying the medical content information to be associated with each other,
stores, in the user behavior information storage, user behavior information that associates user identification information, the tag information corresponding to the medical content information viewed or browsed by a user identified by the user identification information, and a number of times of viewing or browsing per the tag information with one another,
stores, in the user attribute information storage, user attribute information that associates the user identification information and a plurality of pieces of attribute information including viewing/browsing situation information of the medical content information viewed or browsed by the user with each other, normalizes the number of times of viewing or browsing per the tag information to represent a frequency of viewing or browsing by the user,
applies factor analysis processing to the user behavior information after the normalizing to calculate a predetermined number of common factors,
calculates a factor score of the user behavior information after the normalizing based on the predetermined number of common factors per the user identification information, and detects one of the common factors having a highest score as a user characteristic of the user identified by the user identification information,
stores, in the product selective use information memory, product selective use information that associates the user identification information, a plurality of pieces of attribute information of the user identified by the user identification information, and selective use information for a plurality of selective use targets of a plurality of medical products having a same effect as an effect of a medical product used by the user identified by the user identification information,
stores, in the correspondence relation memory, a correspondence relation between the user characteristics, and the selective use targets and the pieces of attribute information, and
applies a multivariate analysis based on the product selective use information, and extracts a factor related to the user characteristic with respect to a usage rate of a predetermined product from among the selective use targets and the pieces of attribute information.

4. An information processing method for an information processing device that comprises: a content information memory; a user behavior information storage; a user attribute information storage; a product selective use information memory; and a correspondence relation memory, the information processing method comprising:
storing, in the content information memory, medical content information viewable or browsable on a Web site and tag information classifying the medical content information to be associated with each other;
storing, in the user behavior information storage, user behavior information that associates user identification information, the tag information corresponding to the medical content information viewed or browsed by a user identified by the user identification information, and a number of times of viewing or browsing per the tag information with one another;
storing, in the user attribute information storage, user attribute information that associates the user identification information and a plurality of pieces of attribute information including viewing/browsing situation information of the medical content information viewed or browsed by the user with each other;
normalizing the number of times of viewing or browsing per the tag information to represent a frequency of viewing or browsing by the user;
applying factor analysis processing to the user behavior information after the normalizing to calculate a predetermined number of common factors;
calculating a factor score of the user behavior information after the normalizing based on the predetermined number of common factors per the user identification information, and detecting one of the common factors having a highest score as a user characteristic of the user identified by the user identification information;
storing, in the product selective use information memory, product selective use information that associates the user identification information, a plurality of pieces of attribute information of the user identified by the user identification information, and selective use information for a plurality of selective use targets of a plurality of medical products having a same effect as an effect of a medical product used by the user identified by the user identification information;
storing, in the correspondence relation memory, a correspondence relation between the user characteristics, and the selective use targets and the pieces of attribute information; and
applying a multivariate analysis based on the product selective use information to extract a factor related to the user characteristic with respect to a usage rate of a predetermined product from among the selective use targets and the pieces of attribute information.

5. The information processing device according to claim 1, wherein
the CPU further:
based on the user identification information that has been extracted, executes at least one of:
issuing an event participation guidance to the user, and
placing an advertisement for the user.

6. The information processing device according to claim 3, wherein
the CPU further:
based on the factor related to the user characteristic that has been extracted, executes at least one of:
issuing an event participation guidance to the user, and
placing an advertisement for the user.

7. A non-transitory computer readable recording medium storing instructions that cause a computer to execute the method according to claim 2.

8. A non-transitory computer readable recording medium storing instructions that cause a computer to execute the method according to claim 4.
